(19) United States
(12) Patent Application Publication
(10) Pub. No.: US 2007/0230579 A1
(43) Pub. Date: Oct. 4, 2007

(54) Serial processing of video signals using a programmable hardware device

(75) Inventors: Sudy Shen, Richmond Hill (CA); David Ewing, Whitby (CA)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Masstech Group Inc., Richmond Hill (CA)

(21) Appl. No.: 11/731,918

(22) Filed: Apr. 2, 2007

Related U.S. Application Data
(60) Provisional application No. 60/788,240, filed on Mar. 31, 2006.

(51) Int. Cl. H04N 11/02; H04N 7/12

(52) U.S. Cl. 375/240.16; 375/240.26

(57) ABSTRACT

Serial processing of video signals is efficiently carried out by the method and system which makes use of specifically configured bitstream processors. The particular bitstream processors utilized include specifically configured decoder blocks and encoder blocks which are uniquely designed to carry out the serial processing tasks necessary for video encoding and decoding operations. These encoder and decoder blocks are uniquely programmed within the bitstream processor, thus providing specific capabilities most beneficial when dealing with video data.

### CROSS REFERENCE TO RELATED APPLICATIONS

This application claims the benefit of U.S. Provisional Application No. 60/788,240, filed Mar. 31, 2006.

### BACKGROUND OF THE INVENTION

The present invention relates to the encoding and decoding of video signals in an efficient manner. More specifically, the present invention is an apparatus and method for increasing the performance of encoding and decoding video data streams by splitting the process of compression and decompression into serial (sequential) and parallel processes. Algorithms and hardware specially developed for the serial processing steps are then employed to maximize efficiency.

Broadcast facilities employ a wide variety of electronic equipment to receive, process and transmit audio-visual content to audiences. While many different components are necessary, one key component in a broadcast content delivery system is a processing system that is capable of receiving and processing audio-visual data (A/V data) so it can ultimately be used for broadcast. A distinguishing characteristic of an A/V processing system, compared with a typical computer system, is the tremendous amount of data that constitutes broadcast quality video. For example, significant processing is required when analog video is received and converted to a digital form. Similarly, when decoding and transcoding operations are required for digital video signals, significant processing is also necessary. Further, an ongoing need exists for managing this large volume of data among various devices within the system in a timely manner, especially during the various steps of encoding or decoding operations.

The various processing components used in broadcast facilities typically have different performance and cost characteristics which often determines how they are used. There are often trade-offs in performance and efficiency for the data processing components usable within the system. Also, trade-offs exist for the types of connections used to interconnect to the components, which control the overall broadcast content management system. For example, certain processors are particularly well suited for sequential processing of data that has timing related information—often referred to as bitstream processors. Similarly, certain operations and certain processors are better suited for parallel processing of data, thus increasing speed and efficiency of the overall system.

As can be appreciated, typical processes involved with A/V data start with the receipt of analog video signals representative of the desired display and sound information. This analog data is typically digitized, processed, and encoded so that it can be more easily managed and/or stored by overall systems controllers. Likewise, A/V data may exist in an encoded format which requires decoding, processing and conversion to an analog signal. In other circumstances, a blended format of analog and digital information is provided, which also must be processed and managed by the system.

In addition to the digitizing of A/V data mentioned above, the management of various data types also creates a further challenge. Currently, there are various types of encoded A/V data in use, with each type having advantages of their own. Handling of these various data types requires coordination by an A/V management system. Often, this requires the conversion or transcoding of digitized A/V data so that the desired information exists in the most appropriate format.

In light of the considerations and issues outlined above, it is desirable to create an overall processing system which efficiently receives and appropriately processes A/V data. This system will appropriately encode, decode or transcode A/V data depending on the format received, and the desired output format.

### BRIEF SUMMARY OF THE INVENTION

The present invention addresses the problems outlined above by providing components and methods for the efficient serial processing of video signals. The processing system is set up to efficiently process A/V data and to deal with the unique challenges of this data. More specifically, the system makes use of uniquely configured encoder and decoder blocks within a bitstream processor to efficiently carry out serial processing of video signals. Generally speaking, this often requires the system to decode or encode audio-visual information but also includes other necessary processing steps. Parallel processing techniques are also used in the overall process, along with specific serial processing components, to efficiently carry out the overall encoding or decoding of video signals. Further, the operations of these processing components are coordinated and managed by a system controller to provide further efficiencies.

The system of the present invention is generally made up of a system controller, which accommodates communication between itself, a memory, a parallel processor, a bitstream processor, a management processor, and several interface modules. Within the system, the bitstream processor is particularly tailored to provide for the effective serial processing of video data. Through these connections, and the particular configuration of each component, the operations of encoding and decoding are efficiently carried out by utilizing the various processing components most advantageously. Generally speaking, the bitstream processor is utilized for serial processing. Similarly, the parallel processor is used for image processing which can be carried out in parallel, thus more efficiently performing those operations. To further coordinate these operations, the system controller makes use of appropriate interface processors and connections. Through the configuration and interconnection of these components, efficient video processing is achieved.

As suggested above, the efficient encoding of analog video signals received by the processing system is one feature of the present invention. Generally speaking, the analog video signal is received at an analog input device which will digitize the signal and transfer it to the system controller for further handling. The system controller can then perform data remapping operations to optimize subsequent operations by a parallel processor. The parallel processor can then further process the digital A/V data, thus producing a partially encoded A/V data signal. From that point, the partially encoded signal is transferred to the bitstream processor. Upon receipt of the partially encoded A/V data, the bitstream processor can perform necessary serial processing to produce a fully encoded A/V data that can then be more easily stored, transferred and/or appropriately utilized by further production systems.

A similar process carried out by the present invention is the decoding of digital video data. As can be anticipated, this process is somewhat similar to the encoding operation outlined above, however carried out in reverse. Most significantly, however, the decoding process again efficiently utilizes both a bitstream processor and a parallel processor. The digitized A/V data (more specifically encoded video data) is typically received by an interface module, and then passed via system controller to the bitstream processor. The bitstream processor itself is capable of performing serial processing on an encoded video stream to produce data in a partially decoded format which is better suited for parallel processing. The partially decoded data is then passed via system controller on to the parallel processor, which is then capable of further decoding operations. Once decoded, the parallel processor is then capable of outputting decoded A/V data to the system controller. Any necessary remapping operations can then be carried out, thus allowing the signal to be transferred from the control processor to the A/V output interface which finally converts the digital A/V signal to an analog video output.

Generally speaking, using the systems and processes outlined above the system of the present invention achieves the effective encoding/decoding/transcoding of A/V signals as necessary. More specifically, the serial processing portions of these processes are most efficiently carried out by using specifically tailored serial processing components.

### BRIEF DESCRIPTION OF THE DRAWINGS

Further objects and advantages of the present invention will be seen by studying the following detailed description, in conjunction with the drawings in which:

FIG. 1 illustrates a block diagram of the video processing system;

FIG. 2 illustrates schematically the data flow during encoding operations;

FIG. 3 illustrates schematically the data flow during decoding operations;

FIG. 4 is a block diagram of a decoder block utilized within the bitstream processor;

FIG. 5 is a block diagram of an encoder utilized in the bitstream processor; and

FIG. 6 is a schematic illustration showing a block remapping operation undertaken by the system controller.

### DETAILED DESCRIPTION OF THE INVENTION

As generally suggested above, the present invention efficiently and effectively implements the encoding and decoding of video signals for an A/V processing system. The advantages of the present invention particularly include the efficient serial processing operations carried out by the bitstream processor. As will be further illustrated below, the efficiency of these operations is achieved largely through the use of specially configured components which are well suited to carry out the particular serial processing operations.

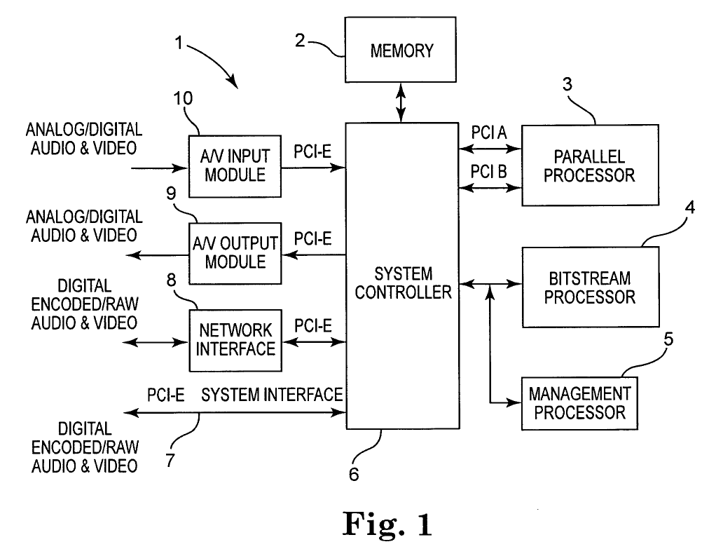

FIG. 1 illustrates the inventive video processing system 1 in a block diagram format, with each block representing a major component of the system. A system controller 6 controls individual data buses used in the system and provides bridging between Peripheral Component Interconnect (PCI) and PCI-Express (PCI-E) buses. System controller 6 also provides overall control and coordination of memory 2, multiple Direct Memory Access (DMA) channels, interrupts and system timing. Connected to System Controller 6 are modules for analog video data input 10 and output 9 and a network interface 8 for the input and output of digital encoded or raw data. A memory module 2, consisting of Random Access Memory (RAM) provides working memory for the DMA channels and also for a bitstream processor 4 and a management processor 5. A system interface 7 provides connectivity to the computer platform on which processing system 1 resides. Also connected to system controller 6 via dual normal PCI buses is a parallel processor 3 which consists of multiple Single Instruction Multiple Data (SIMD) processors which cooperate to process encoding/decoding/transcoding operations in parallel. Bitstream processor 4 complements the parallel processor by handling the aspects of the encode, decode or transcode processes that must be handled sequentially including bitstream parsing and generation. In a preferred embodiment bitstream processor 4 is implemented in a Field Programmable Gate Array (FPGA) or similar programmable hardware to enhance operating performance. Management processor 5 manages the peripheral input/output cards, manages and schedules the data flow between bitstream processor 4 and parallel processor 3, loads instruction code into the bitstream processor 4 and parallel processor 3 and provides a control point for external (system) applications to access the system's resources via the system interface 7. The above description of the inventive apparatus and method pertains to only the video portion of an audio/video data bitstream; the audio portion of the audio/video data is processed by management processor 5 or by the external system processor (not shown) in a conventional manner.

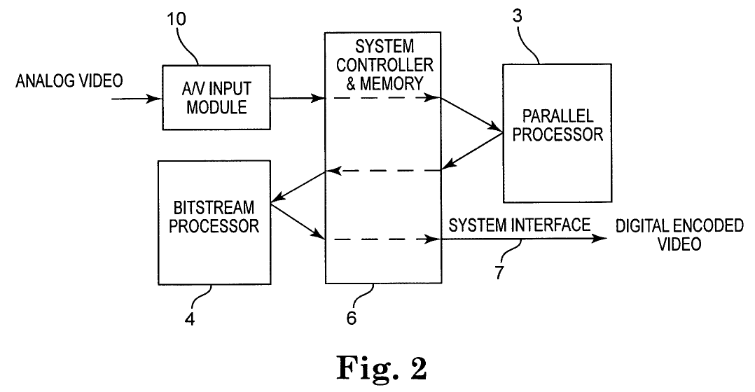

FIG. 2 illustrates schematically the flow of analog video data from A/V input module 10 until it is output as a digitally encoded video signal. Once received at A/V input module 10, the signal is digitized, passed through system controller 6 and into RAM (memory module 2) where it is block re-mapped and transferred via a DMA channel to parallel processor 3. At that point, the information is stored in local memory and encoded in parallel. The parallel encoded image is then DMA transferred from parallel processor data memory to RAM in memory module 2. Next, the encoded image is transferred to bitstream processor 4 which completes the data encoding and generates a bitstream of encoded video data. From there the digitally encoded video data stream is sent via DMA to system interface 7.

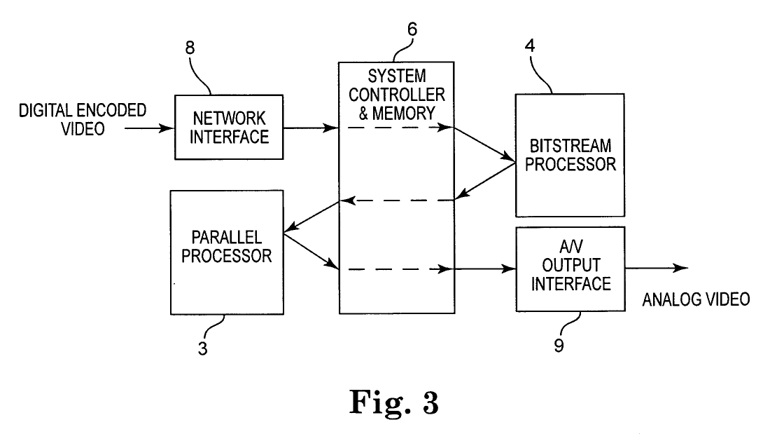

FIG. 3 illustrates schematically the decoding process of the present video processing method and system. Encoded video data flows from a network interface module 8 through system controller 6 and into RAM (memory module 2). From RAM the encoded video stream is parsed by the bitstream processor 4 and the data is partially decoded before a DMA transfer to parallel processor 3 where the decoding is finished. Another DMA transfer moves the data back to RAM where a pixel remap of the data is performed followed by an optional unpacked to packed pixel conversion. Finally, the decoded and remapped data is sent by DMA transfer to A/V output Interface card 9 where it is converted to analog video.

To provide efficient operation, the system of the present invention makes use of both bitstream processor 4 and parallel processor 3. Each of these processors are specifically configured to more efficiently carry out certain steps or portions of any necessary video signal processing. Further information regarding the encoding, decoding and transcoding of A/V data can be found in applicant's co-pending application entitled “Encoding, Decoding, and Transcoding of Audio/Visual Signals Using Combined Parallel and Serial Processing Techniques”, U.S. application Ser. No. ______, filed concurrently with the present application and incorporated herein by reference.

During encoding or decoding operations, the operation of the bitstream processor is especially significant due to the unique operations that must be carried out. As such, the present invention utilizes a specifically configured bitstream processor which is tailored towards the necessary serial processing of video signals. As suggested above, bitstream processor 4 is typically implemented in a Field Programmable Gate Array (FPGA), or similar hardware. Specific components with bitstream processor 4 further include encoder blocks and decoder blocks. These particular blocks are further programmed within the FPGA to specifically manage and handle those serial processes being carried out.

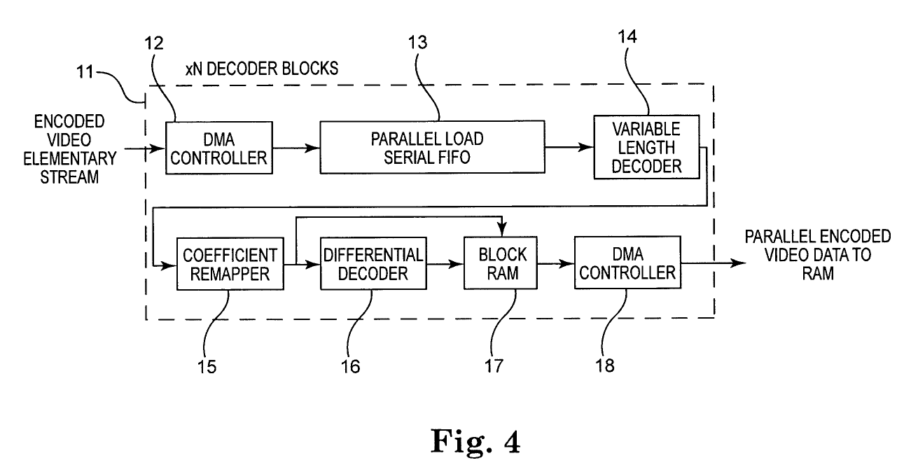

Turning now to FIG. 4 the major components of a decoder block 11 programmed within FPGA bitstream processor 4 are illustrated in a block diagram format. Although only one instance of decoder block 11 is illustrated, multiple instances of decoder block 11 can be running within bitstream processor 4, thus being capable of decoding multiple video elementary streams encoded in different encoding formats. An elementary stream of encoded video data is received in parallel from external RAM via DMA controller 12 and is shifted serially to the end of a First-In-First-Out (FIFO) data store 13. Next, the stored data is compared to bitstream syntax elements stored in the variable length decoder module 14. Variable length decoder 14 performs a Huffman or equivalent decoding of the variable sized data code words and generates fixed sized data. In the preferred embodiment, a plurality of functional decoding blocks exist within variable length decoder module 14, thus providing an ability to decode the bitstream despite variations in syntax. Each functional decoding block 11 can be loaded with one of a plurality of decoder maps each appropriate for a different bitstream syntax element. When a functional decoding block 11 is not being actively used to decode a bitstream element, it can be preloaded with a decoder map suitable for the next expected bitstream syntax element. After variable length decoding, bitstream data is sent to a coefficient remapping module 15 where coefficient data is copied to block RAM 17 using a zigzag copy out pattern. The bitstream data is also subsequently run-length decoded by coefficient remapper 15. Block RAM 17 is configured to store the data for one block of bitstream video data and in a preferred embodiment stores data for 64 (8×8) pixels with each pixel consisting of 8 bits of video coefficient data and 8 bits of control word data. After run length decoding, programming control is passed to a differential decoding module 16 which performs a differential decoding of intra block coefficients and decodes motion vector data for inter coded data blocks. A DMA controller 18 finally copies decoded data from block RAM 17 to memory within parallel processor 3 for further decoding operations.

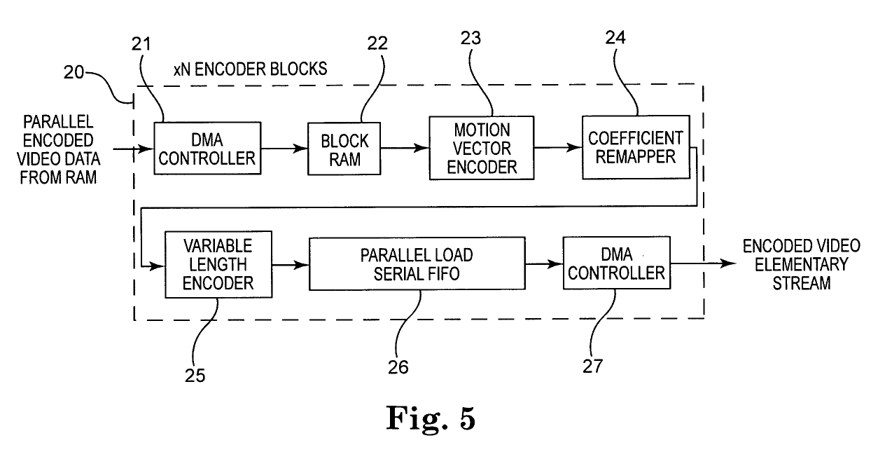

FIG. 5 is a block diagram representing the major components of an encoder block 20 programmed within FPGA bitstream processor 4. As with decoder blocks 11, multiple instances of encoder block 20 can be running within bitstream processor 4, thus capable of producing multiple video elementary streams of different encoding formats. To initiate the serial encoding process, parallel encoded video data stored in parallel processor 3 memory is sent via DMA controller 21 to Block RAM 22 which has the capacity to store one block (8×8 pixels) of data. Each pixel within a data block consists of a 16 bit word; 8 bits video coefficient data and 8 bits control word data for the bitstream encode process. A motion vector encoder 23 is applied to motion vectors associated with the inter-coded blocks. A coefficient remapping module 24 then copies coefficient data to a variable length encoder block 25 using a zigzag copy out pattern and performs run length encoding on the data. Variable length encoder 25 performs Huffman or equivalent coding of fixed size data and generates variable sized code words. In the preferred embodiment, a plurality of functional blocks 20 are utilized, each functional block being selectively loaded with appropriate code maps applicable to the bitstream syntax element being processed. When a functional coding block 20 is not actively coding data it can be loaded with a code map for the next expected syntax element. Code words are then written to a parallel loaded serial FIFO data store 26 and are shifted serially to the end of the FIFO at which point the bitstream (elementary stream of encoded video) is written in parallel to external RAM by output controller 27.

In order to provide coordination amongst the various components, it is often necessary to remap video data. Generally speaking, this remapping allows for more efficient processing by the parallel processor 3. Naturally, the same remapping process is beneficial after parallel processing has occurred.

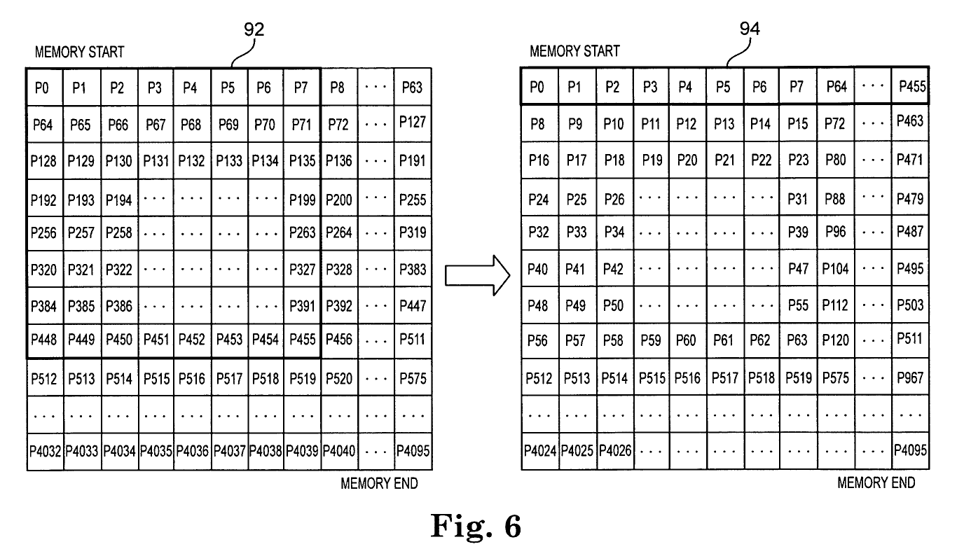

FIG. 6 is a schematic showing the memory remapping required to move from pixel to block oriented memory for use in the parallel processor 3. The operation of remapping the video data to a block orientation prior to parallel processing is desirable because it increases the system's efficiency in loading and processing the data. A hypothetical 64×64 pixel image is illustrated in FIG. 6 having 8×8 pixel blocks. Pixel block 92 is indicated by the dark boundary and its constituent pixels are arranged as they would appear on a raster scanned device such as a monitor or projector. In the second diagram, the pixels have been re-mapped resulting in pixel block 92 being transformed to pixel block 94 which contains the same pixels as block 92 but is transformed from an 8×8 array to a 1×64 array. This new orientation allows whole blocks to be loaded/unloaded into SIMD processors without the need for special memory access routines which would hamper the parallel processor performance.

The inventive apparatus and method for encoding, decoding and transcoding video data significantly decreases the time required for data processing allowing system operators to offer enhanced services and/or lower costs to customers. The use of a Field Programmable Gate Array or equivalent device for the serial processing portions of compression and decompression provides the opportunity for system scalability, operational flexibility and increased system performance.

What is claimed is:

1. A video processing system for serial processing of a/v data, comprising:
a system controller
an a/v input module for receiving a/v signals, the a/v input module having an output coupled to the system controller for outputting a/v signals;
an a/v output module for outputting a/v signals, the a/v output module having an input coupled to the system controller for receiving a/v signals;
a parallel processor for processing a/v data coupled to the system controller; and
a bitstream processor for performing serial data processing operations coupled to the system controller, the bitstream processor further comprising:
at least one decoder block for decoding video data, wherein each decoder block comprises a fifo register for receiving an encoded video stream and serially storing in an ordered manner, a variable length decoder for operating on the encoded video stream to generate a stream of video data having fixed data size, a coefficient remapper for receiving the fixed size video data stream and determining coefficient information and storing in a block memory a block bitstream video data, wherein the block of bitstream video data corresponds to a predetermined block of pixel data, and a differential decoder for decoding motion vectors and producing a decoded video data stream for transfer to the parallel processor for further processing; and
at least one encoder block for encoding video data, wherein each encoder block comprises a memory for receiving parallel encoded video data from the parallel processor and storing one block of video data, a motion vector encoder for applying motion vectors to the block of video data, a coefficient remapping module for attaching coefficient data to the block of pixel data, a variable length encoder for coding block of pixel data thus creating video data having variable length code words corresponding to the pixels, and a fifo register for receiving the variable length and producing a serial bitstream of encoded video data.

2. The system of claim 1 wherein the variable length encoder is loaded with a predetermined code map.

3. The system of claim 1 wherein the variable length decoder is loaded with a predetermined code map.
